(19) United States
(12) Patent Application Publication
(10) Pub. No.: US 2010/0184548 A1
(43) Pub. Date: Jul. 22, 2010

(54) INJECTION MOLDED PULLEYS HAVING LOW LEVELS OF OUT-OF-ROUNDNESS

(75) Inventors: Robert Paul Langlois, Mason, OH (US); Jay Addison Haverstraw, Cincinnati, OH (US); Lowell Green, East Enterprise, IN (US); Daniel Lawrence Bell, Blue Ash, OH (US)

Correspondence Address: MAURICE M KLEE, 1951 BURR STREET, FAIRFIELD, CT, 06824, US

(73) Assignee: PLASTIC MOLDINGS COMPANY, LLC, Cincinnati, OH (US)

(21) Appl. No.: 12/664,165

(22) PCT Filed: Jun. 15, 2007
(86) PCT No.: PCT/US2007/014026

§ 371 Date: Dec. 11, 2009

(51) Int. Cl. F16H 55/48; B29C 45/14

(52) U.S. Cl. 474/190; 264/279

(57) ABSTRACT

Injection molded plastic pulleys (10) reinforced with glass fibers (at least 15 weight percent) are provided which exhibit low levels of out-of-roundness. The low levels of out-of-roundness can be achieved without the need for machining through the use of disc gating and perimeter venting. The pulleys (10) have belt-engaging surfaces (15) whose out-of-roundness is less than or equal to 35 microns when measured at any location up to 1 millimeter from the outside edges (16) of the belt-engaging surface (15).

### I. FIELD OF THE INVENTION

This invention relates to injection molded pulleys and, in particular, to injection molded pulleys that exhibit low levels of out-of-roundness.

### II. BACKGROUND OF THE INVENTION

Injection molded pulleys are widely used in a variety of industries. One of the most common uses is in the automobile industry where such pulleys are used in connection with the serpentine belts that transfer power from a vehicle's crankshaft to various accessories, such as, alternators, air conditioning units, water pumps, power steering pumps, and the like.

Two types of pulleys are used in these applications: (1) pulleys having belt-engaging surfaces which include grooves to guide the motion of the belt and (2) pulleys having belt-engaging surfaces which are flat. The present invention is applicable to both types of pulleys. It is also applicable to pulleys having gear teeth, such as the pulleys used with timing belts.

Typically, engines used in commercial vehicles have rates of rotation of less than about 8,000 rpm. Thus, the main pulley attached to the vehicle's crankshaft rotates at this rate. However, other pulleys engaged by the serpentine belt can rotate at much higher rates. For example, idler pulleys used to guide the belt along its serpentine path can have rotation rates on the order of 2 or more times greater than that of the main pulley. Accordingly, such pulleys can rotate at rates above 15,000 rpm.

A primary product parameter which leads to suitable pulley performance at elevated rpm's is the roundness of the pulley's belt-engaging surface. Out-of-roundness of the belt-engaging surface is of primary importance since this surface contacts the belt and is the part of the pulley that is farthest from the pulley's center of rotation. As a result, even small non-uniformities in the pulley's belt-engaging surface can have large effects in generating vibration.

In addition to vibration, other problems associated with out-of-roundness include bearing noise, bearing failure, belt noise, belt wandering, belt failure, and the like. Although these problems are most severe at high rpm's, they also exist at lower rpm's. Accordingly, there has been a long felt need in the industry for pulleys which have low levels of out-of-roundness.

Steel pulleys have historically dominated the vehicle market since they can be manufactured with uniform mass distribution throughout the body of the pulley and with low levels of out-of-roundness of the pulley's belt-engaging surface. The problems with steel pulleys are weight and cost. With the ever increasing demand for higher fuel efficiency, lowering of overall vehicle weight has become a primary goal of vehicle manufacturers. Lower cost has always been important, but has become even more so with global competition.

As a result, substantial efforts have been made to use plastic materials to form pulleys. This has turned out to be a challenging problem from a number of points of view. To begin with, plastics are weaker than steel and thus it has been found necessary to used reinforced plastics, specifically, glass-reinforced plastics. However, molding (e.g., injection molding) of glass reinforced plastics is challenging, especially at the glass loading levels needed to provide the required strength, e.g., loading levels of 15-50% by weight.

In general, glass fibers provide higher strength levels than glass beads. However, in the past, it was found that injection molding of plastics containing glass fibers resulted in pulleys having belt-engaging surfaces with substantial levels of out-of-roundness (e.g., 110 microns or more).

Accordingly, the industry has been faced with three options, none of which has been satisfactory:
(1) use glass beads for reinforcement and thereby sacrifice pulley strength;
(2) accept the high levels of out-of-roundness associated with glass fiber reinforcement and suffer the resulting problems associated with out-of-roundness; or
(3) use glass fibers for reinforcement and then machine the belt-engaging surface to achieve a suitable level of out-of-roundness, while accepting (i) the increased cost and complexity of the resulting manufacturing process and (ii) the creation, through machining, of exposed glass fiber ends at the belt-engaging surface that can damage the belt.

In view of this state of the art, there exists an industry wide need for improved plastic pulleys. The present invention addresses this long-felt and substantial need.

### III. SUMMARY OF THE INVENTION

In accordance with a first aspect, the invention provides a pulley (10) for engagement with a belt comprising:

(A) an injection-molded body (12) composed of a plastic material filled with a glass fiber reinforcing material; and

(B) a bearing (14) which is partially encapsulated in the body (12); wherein:
(i) the body (12) has a non-machined, belt-engaging surface (15) which has a diameter D and a circumferential centerline (17);
(ii) the belt-engaging surface (15) has an outside-edge-to-outside-edge width of at least 20 millimeters;
(iii) the belt-engaging surface (15) has an out-of-roundness (i.e., an average out-of-roundness over a population of parts) which is:
   (a) less than or equal to 30 microns when measured at the circumferential centerline (17) of the belt-engaging surface (15);
   (b) less than or equal to 30 microns when measured at ±6 millimeters of the circumferential centerline of the belt-engaging surface (see 17a and 17b); and
   (c) less than or equal to 35 microns when measured at any location up to 1 millimeter from (i.e., inboard of) the outside edges (16) of the belt-engaging surface (15);
(iv) the glass fiber reinforcing material comprises at least 15% by weight of the body (12); and
(v) the aspect ratio of at least 50% of the glass fibers of the glass fiber reinforcing material is at least 50:1.

In accordance with a second aspect, the invention provides a method of producing a plastic pulley (10), said pulley (10) having a belt-engaging surface (15) which has a first edge (16) and a second edge (16), said method comprising injection molding a plastic material containing glass fibers around a bearing (14) using a disc gating process wherein the mold used in the injection molding process has perimeter vents (50,52) at both the first and second edges (16) and the belt-engaging surface (15) of the molded pulley (10) without any machining has an out-of-roundness which is less than or equal to 35 microns when measured at any location up to 1 millimeter from (i.e., inboard of) the first and second edges (16) of the belt-engaging surface (15).

As indicated above, the belt-engaging surfaces of the pulleys of the invention are non-machined surfaces. That is, the belt-engaging surfaces are “as-molded” surfaces. This significantly decreases the cost of the pulley's plastic body 12, e.g., by as much as 25 percent.

A machined surface is readily distinguished from an as-molded surface by examination of the surface either by eye or with a magnifier or microscope. The machined surface shows machining marks where the tool used to perform the machining operation has engaged the surface. An as-molded surface, on the other hand, is free of such machining marks.

In addition to these visible differences between machined and as-molded surfaces, the two types of surfaces also have functional differences. The machining process exposes the ends of glass fibers which can result in higher belt wear rates as the belt passes over the exposed sharp edges of the fibers. An as-molded surface, on the other hand, is “resin rich” and thus provides a smooth surface with little or no exposed fibers, thus leading to reduced levels of belt wear. Purchasers thus prefer pulleys having as-molded surfaces as compared to pulleys having machined surfaces.

The above numerical values of 30 microns at and near the centerline of the pulley and 35 microns over the entire operative width of the belt-engaging surface are threshold values for addressing the problems arising from out-of-roundness. Although even lower levels of out-of-roundness can improve performance somewhat, one quickly reaches a region of diminishing returns in view of other sources of vibration, noise, and wear associated with the use of pulleys in vehicles. Thus, in accordance with certain preferred embodiments of the invention, the out-of-roundness at the centerline and at ±6 millimeters from the centerline is approximately 25 microns. Lower values will, in general, provide minimal added benefit to the users of plastic pulleys.

The reference symbols used in the above summaries of the various aspects of the invention are only for the convenience of the reader and are not intended to and should not be interpreted as limiting the scope of the invention. More generally, it is to be understood that both the foregoing general description and the following detailed description are merely exemplary of the invention, and are intended to provide an overview or framework for understanding the nature and character of the invention as it is claimed.

Additional features and advantages of the invention are set forth in the detailed description which follows, and in part will be readily apparent to those skilled in the art from that description or recognized by practicing the invention as described herein. Both these additional aspects of the invention and those discussed above can be used separately or in any and all combinations.

The accompanying drawings are included to provide a further understanding of the invention, and are incorporated in and constitute a part of this specification. The drawings illustrate various embodiments of the invention, and together with the description serve to explain the principles and operation of the invention. In the drawings and the specification, like parts in related figures are identified by like reference symbols.

### IV. BRIEF DESCRIPTION OF THE DRAWINGS

FIG. 1 is perspective view of a pulley constructed in accordance with a preferred embodiment of the invention.

FIG. 2 is a cross-sectional view of the pulley of FIG. 1.

FIG. 3 is a schematic drawing illustrating a determination of the level of out-of-roundness of the pulley's belt-engaging surface. The out-of-roundness of the belt-engaging surface in this figure has been exaggerated for purposes of illustration.

FIG. 4 is a cross-sectional view of a partially disassembled mold that can be used to produce a low out-of-roundness pulley. For purposes of illustration, the glass fiber reinforced material that will form the pulley is shown in this figure and in FIG. 5.

FIG. 5 is a cross-sectional view of the mold of FIG. 4 after assembly and insertion of the pulley's bearing and the pin for disc gating.

FIG. 6 is a computer simulation showing fiber orientation for multiple gating (FIG. 6A), single gating (FIG. 6B), and disc gating (FIG. 6C). The gates are shown in these figures by solid arrows.

FIG. 7 is a computer simulation showing material pressure profiles for multiple gating (FIG. 7A), single gating (FIG. 7B), and disc gating (FIG. 7C). The gates are shown in these figures by solid arrows.

FIG. 8 is a computer simulation showing volumetric shrinkage for multiple gating (FIG. 8A), single gating (FIG. 8B), and disc gating (FIG. 8C). The gates are shown in these figures by solid arrows.

The reference symbols used in the figures correspond to the following:

10 pulley

12 plastic body

14 bearing

15 belt-engaging surface

16 outer edges of belt-engaging surface

17 circumferential centerline of the belt-engaging surface

17a circumferential +6 mm line of the belt-engaging surface

17b circumferential −6 mm line of the belt-engaging surface

18 ribs

20 plastic hub for retaining the bearing

22 inner race

24 outer race

26 ball bearings

28 bearing seals

30 circular element of belt-engaging surface

32 axis of best fit to circular element

34 outer bound circle for roundness determination

36 inner bound circle for roundness determination

37 out-of-roundness

38 main cavity insert

40 cavity sub-insert

41 pin

42 pin head

43 pin shaft

44 hub ejector pin

46 pin ejector pin

48 jig-ground mold surface

50 parting line perimeter vent

52 cavity sub-insert perimeter vent

54 bearing-engaging surface

56 knitline on bearing-engaging surface

58 knitline on belt-engaging surface

### V. DETAILED DESCRIPTION OF THE INVENTION AND ITS PREFERRED EMBODIMENT

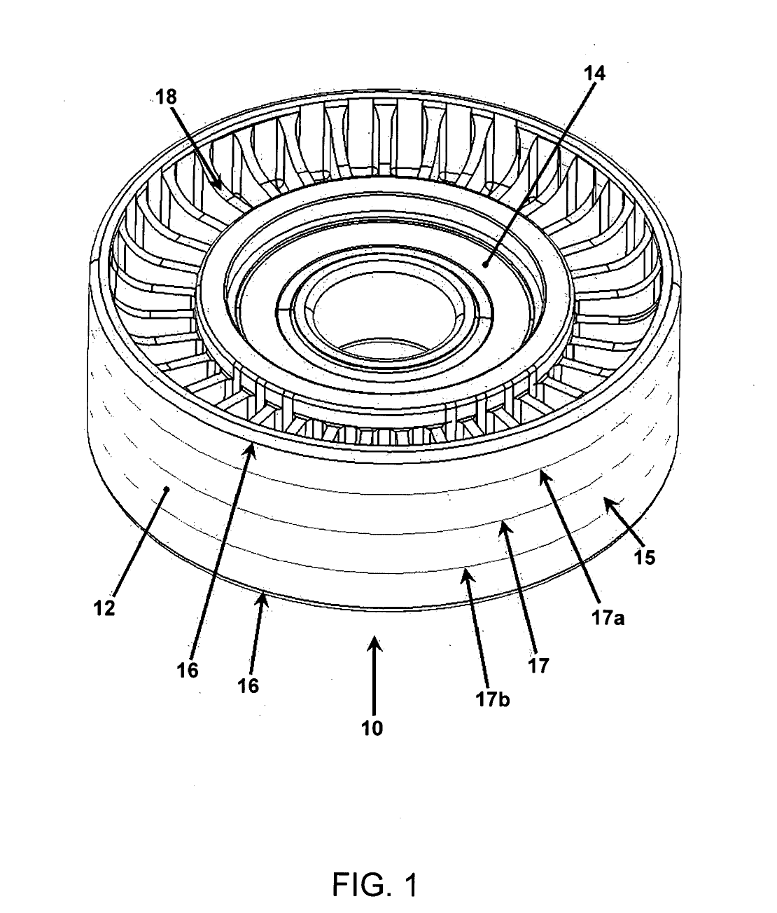

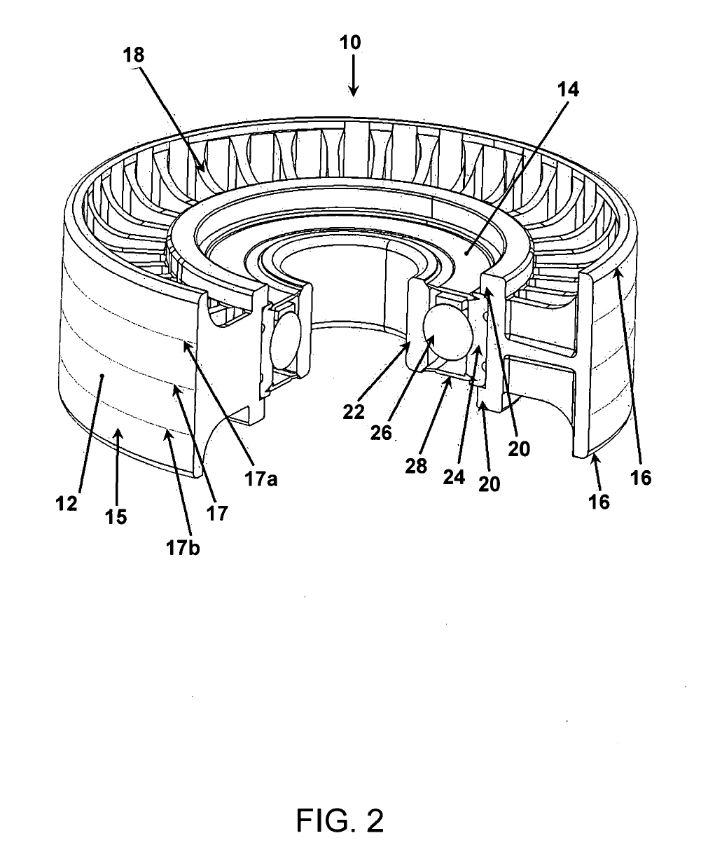

FIGS. 1 and 2 show a representative pulley of the type with which the present invention can be used. As can be seen in these figures, pulley 10 includes a plastic body 12 with a set of ribs 18 which connect a hub 20 to belt-engaging surface 15. The hub 20 retains (encapsulates) the outer race 24 of bearing 14. As is conventional, the bearing also includes an inner race 22, ball bearings 26, and bearing seals 28. Although not shown in FIGS. 1 and 2, a dust shield can be used with the pulley assembly to protect bearing 14 from environmental contamination during use.

Although shown with a flat surface in FIGS. 1 and 2, belt-engaging surface 15 can have a variety of other configurations, including a circumferential grooved structure in the case of a main pulley or a pulley used at an accessory, or a toothed structure in the case of, for example, a timing pulley used as part of a engine timing mechanism. Pulleys having flat belt-engaging surfaces are typically used as idler pulleys or as part of pretensioning mechanisms.

Body 12 can be made of a variety of plastic materials, including thermoplastic and thermoset materials, thermoplastics being preferred. For example, the body can be made of nylon 6, which is a low cost plastic which exhibits relatively high strength for its cost, as well as resistance to heat and petroleum products, such as gasoline and lubricating fluids.

To provide sufficient strength to withstand the forces applied to the pulley, the plastic material of body 12 is filled with a glass reinforcing material. In particular, the glass reinforcing material comprises at least 15% by weight of the body and preferably at least 30% by weight. To ensure adequate wetting of the reinforcing material by the plastic material and to ensure adequate flow for successful injection molding, the weight percentage of the glass reinforcing material should be less than about 65%. Preferably, the weight percent of the glass reinforcing material is approximately 50%.

The glass reinforcing material is in the form of glass fibers, as opposed to glass beads. As discussed above, glass beads were used in the past to reinforce plastic pulleys since such beads did not compromise the pulley's out-of-roundness. However, glass beads are inferior in providing the pulley with the physical properties needed for vehicle and other applications. In particular, compared to pulleys filled with glass fibers, pulleys filled with glass beads exhibit lower bearing retention strength, higher rates of wear of the belt-engaging surface, and overall lower durability of the pulley during use.

In general, the improved properties achieved with glass fibers increases as the fiber's aspect ratio increases. Thus, the aspect ratio of at least 50% of the glass fibers of the reinforcing material used in the pulleys of the invention is at least 50:1 and preferably at least 100:1. In terms of physical dimensions, the glass fibers preferably have an average diameter of approximately 12 microns. The glass fibers can have various compositions known in the art for reinforcing fibers.

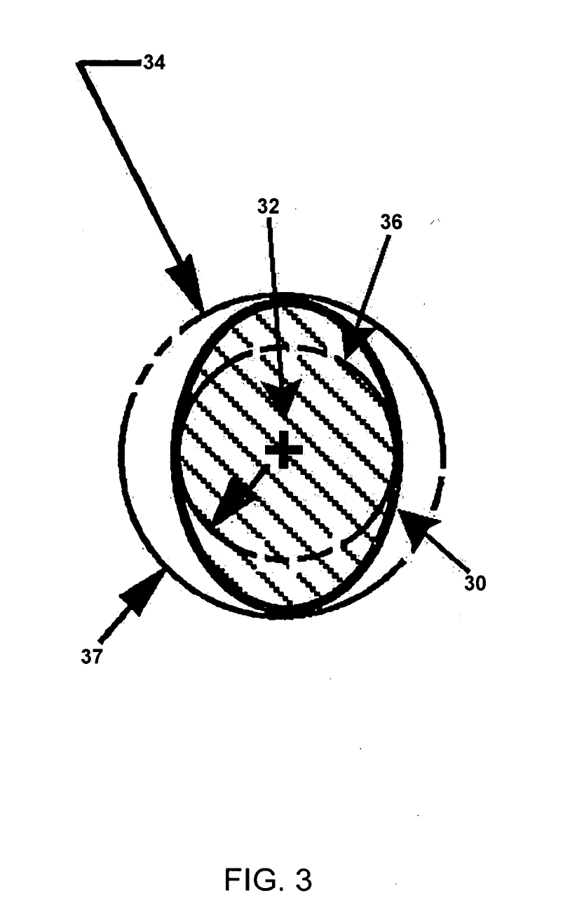

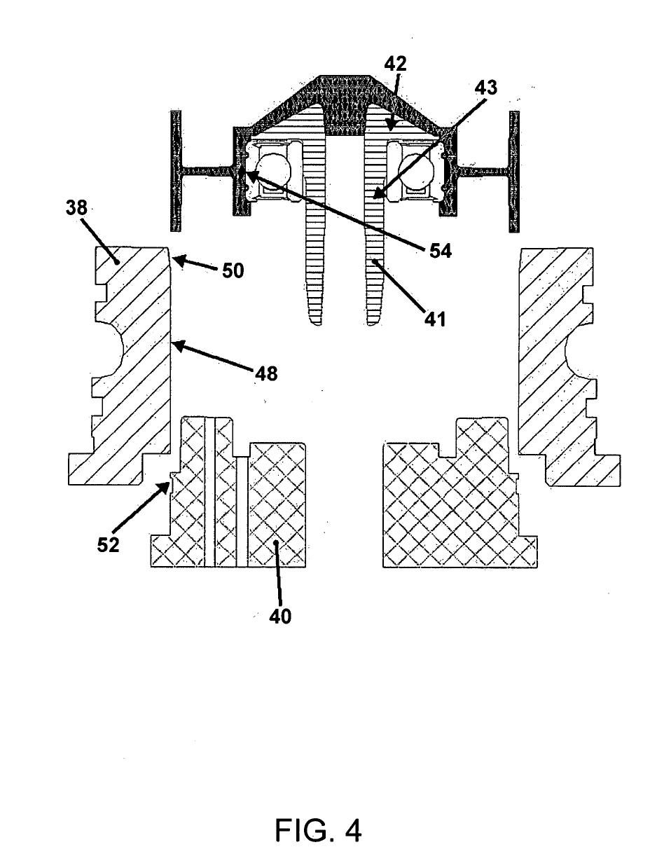

FIG. 3 illustrates the determination of the out-of-roundness of a pulley. Reference number 30 in this figure represents a circular (circumferential) element of the belt-engaging surface, e.g., circular elements 17, 17a, or 17b in FIGS. 1 and 2, or another circular element, e.g., a circular element spaced 1 millimeter from an edge 16 of the belt-engaging surface 15. Reference numbers 34 and 36 in FIG. 3 represent, respectively, the maximum circle that contains circular element 30 and the minimum circle that is contained within circular element 30, where the maximum and minimum circles have a common center axis 32 which is the axis of best fit to circular element 30. The out-of-roundness is then the difference between the radii of circles 34 and 36, as shown at 37 in FIG. 3.

The actual measurement of the shape of the belt-engaging surface of the pulley can be made using various commercially-available equipment, e.g., a roundness tester manufactured by Taylor-Hobson, Mitutoyo, or similar suppliers. The out-of-roundness values reported below were measured using a Mitutoyo roundness tester.

In practice in the automobile industry, out-of-roundness is determined for the centerline of the pulley (line 17 in FIGS. 1 and 2), as well as the ±6 millimeter lines (lines 17a and 17b in FIGS. 1 and 2). In addition, to provide an even more severe test, out-of-roundness measurements can be made over the entire surface of the belt-engaging surface up to 1 millimeter from the edges, where edge effects, e.g., the lack of support by ribs 18, come into play.

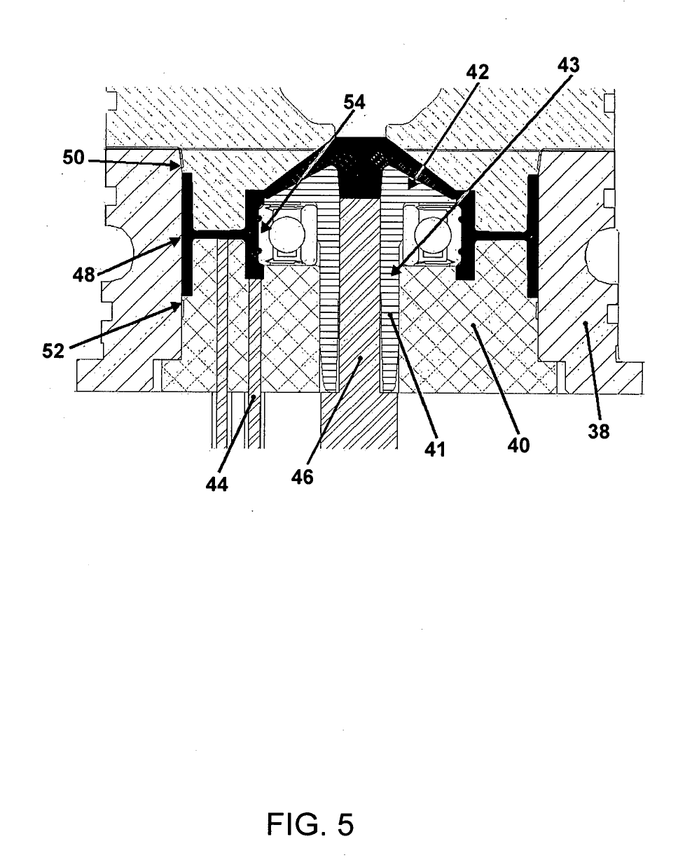

The pulleys of the present invention are preferably manufactured using a technique of the type disclosed in commonly-assigned U.S. Pat. No. 6,517,757, the contents of which are incorporated herein in their entirety by reference. FIGS. 4 and 5 illustrate a preferred cavity design for molding the pulleys of the invention in accordance with this patent. As shown in these figures, the cavity design includes a main cavity insert 38 and a cavity sub-insert 40. During use, cavity sub-insert 40 is mounted in main cavity insert 38.

To produce a pulley, bearing 14 and pin 41 are mounted in cavity sub-insert 40, with the pin's shaft 43 inserted into the bearing's inner race 22. The pin's head 42 is located above the bearing and serves to form a disc gate for the fiber-filled plastic material during the injection molding process. Once the mold is assembled and clamped in the molding machine, fiber-filled plastic material is injected around bearing 14 using conventional injection molding processing technology. During the molding process, the mating surfaces between main cavity insert 38 and the top half of the mold (not shown) form a parting line perimeter vent 50.

Once the plastic injection process is completed and the plastic has solidified, the resulting part is removed from the mold using hub ejector pin 44, pin ejector pin 46, and other ejector pins (not shown). Thereafter, pin 41 is removed from bearing 14 using, for example, a punch press. The removal of pin 41 severs the disc gate formed during the molding process from the top surface of the pulley. This removal of pin 41 produces the finished pulley without any machining or polishing of the belt-engaging surface, i.e., the belt-engaging surface has “as-molded” surface characteristics.

To achieve low levels of out-of-roundness, mold surface 48 for forming the belt-engaging surface is preferably jig ground. In addition, as discussed in the Comparative Example set forth below, to achieve out-of-roundness levels of less than 35 microns over the entire operative width of the belt-engaging surface, the mating surfaces between cavity sub-insert 40 and main cavity insert 38 are provided with a parting line perimeter vent 52.

Specifically, a gap of approximately 12-25 microns is provided between the mating surfaces of sub-insert 40 with main insert 38 around the entire perimeter of what will become edges 16 of the belt-engaging surface of the pulley. This gap in combination with parting line perimeter vent 50 has been found to produce a belt-engaging surface which exhibits an out-of-roundness level of less than 35 microns over the entire operative width of the surface. This level of out-of-roundness, resulting from the combination disc gating and the use of vents 50 and 52, was unexpected, especially in view of the prior belief in the art that low levels of out-of-roundness for glass fiber filled plastic pulleys could only be achieved through machining of the belt-engaging surface.

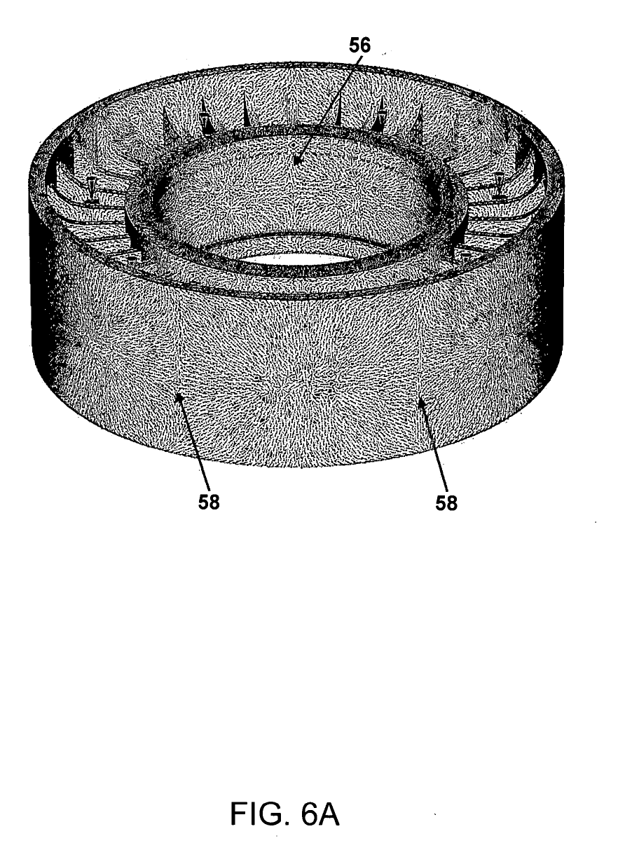

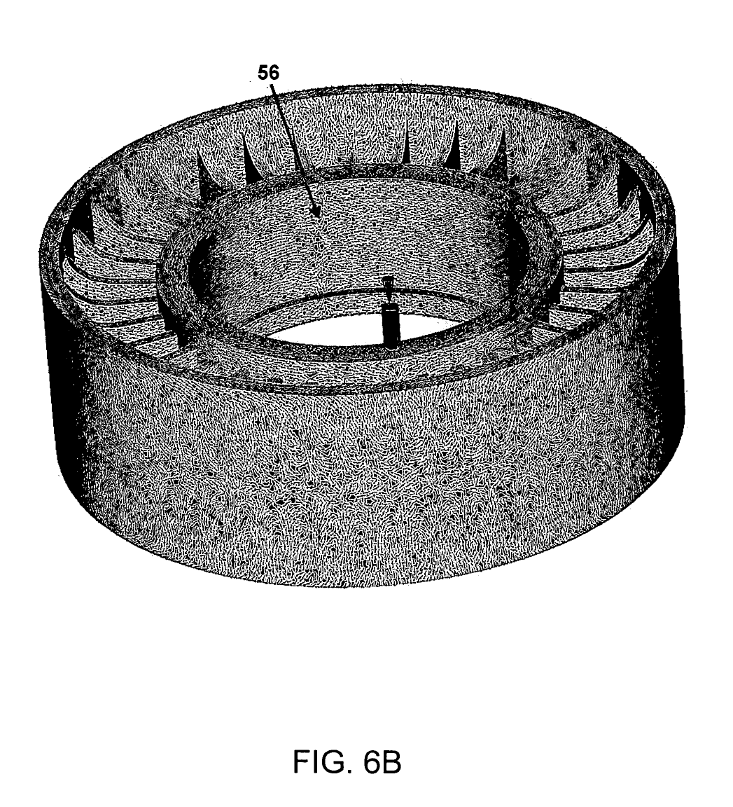

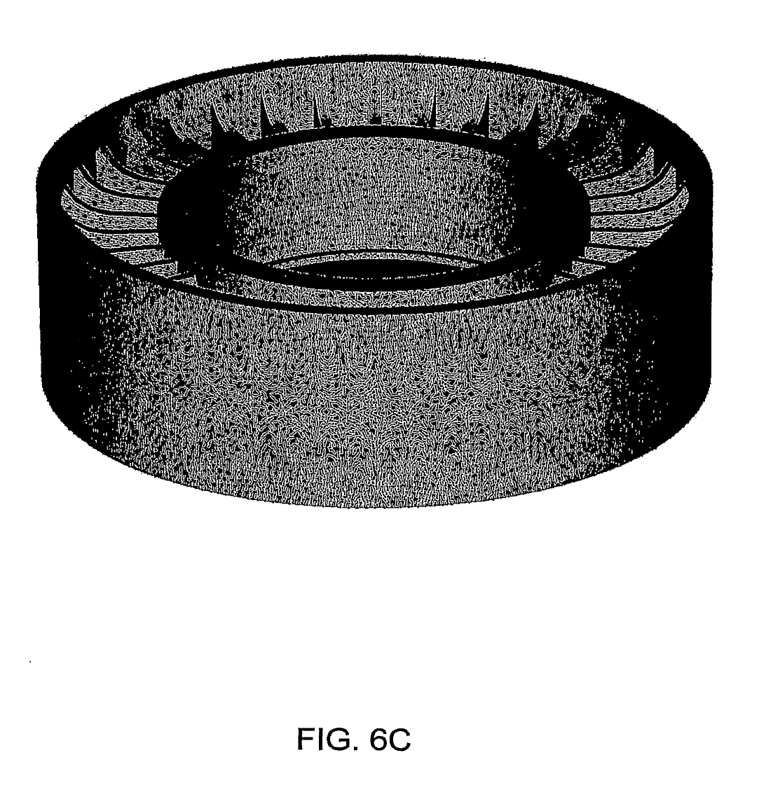

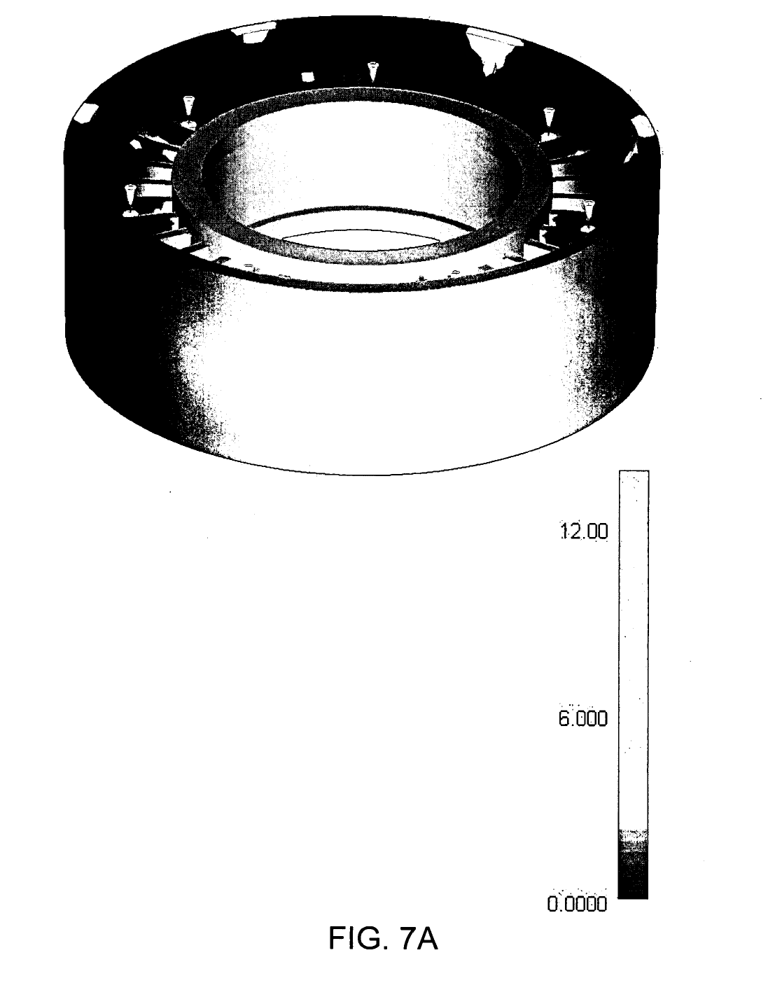

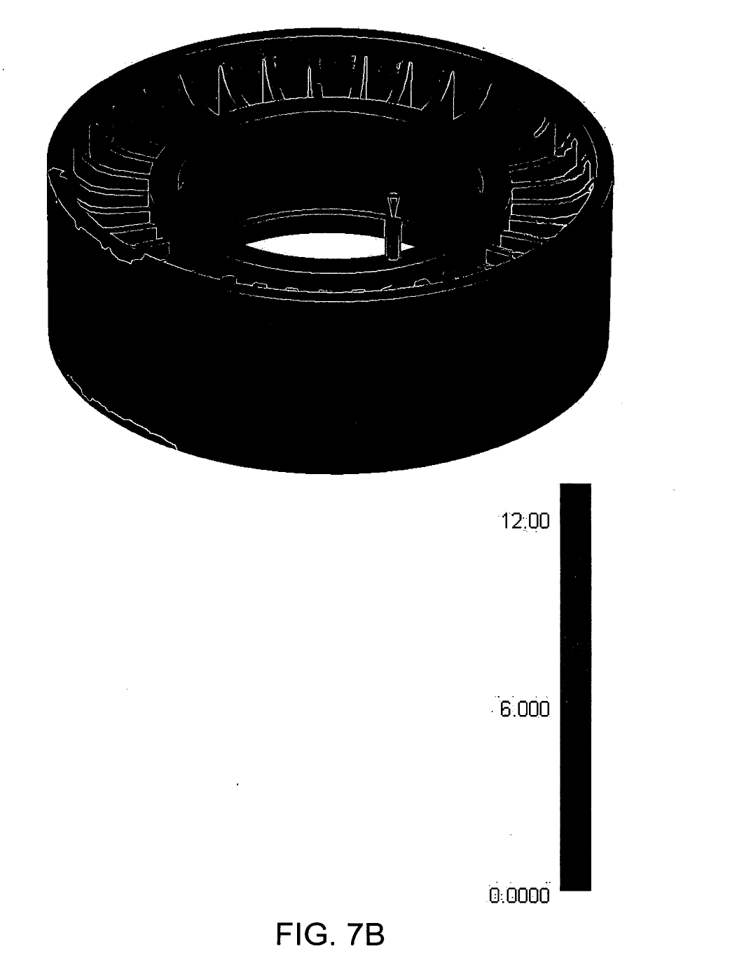

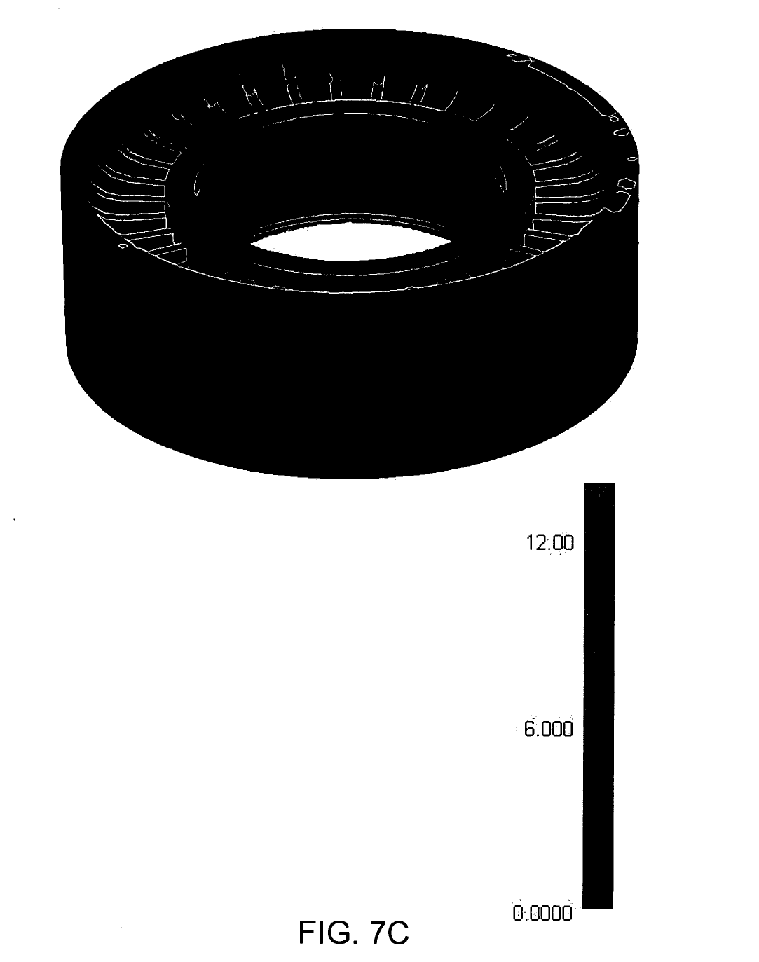

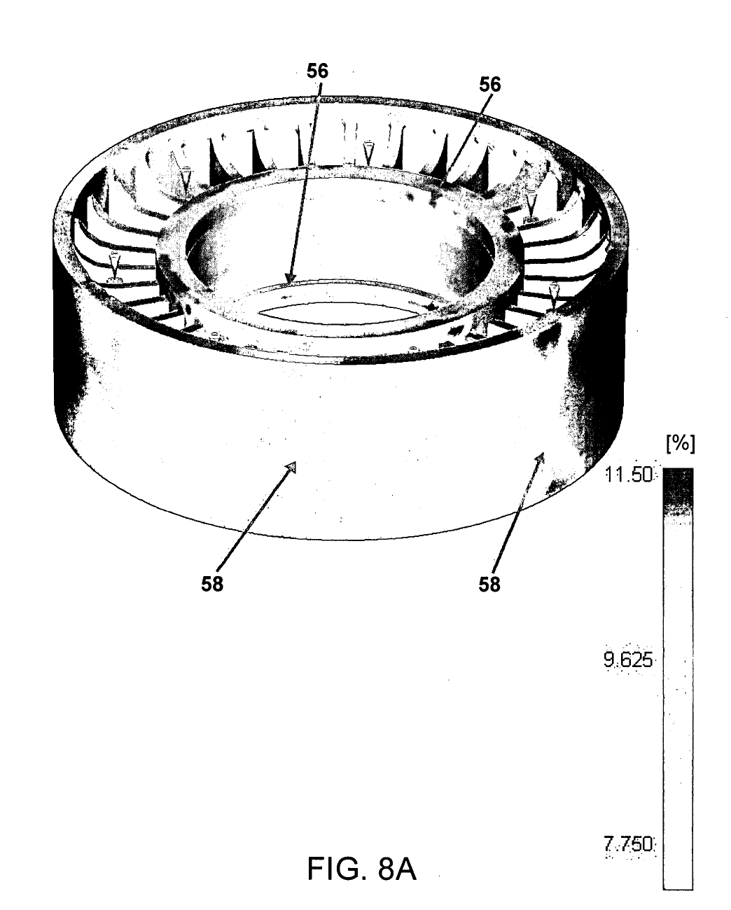

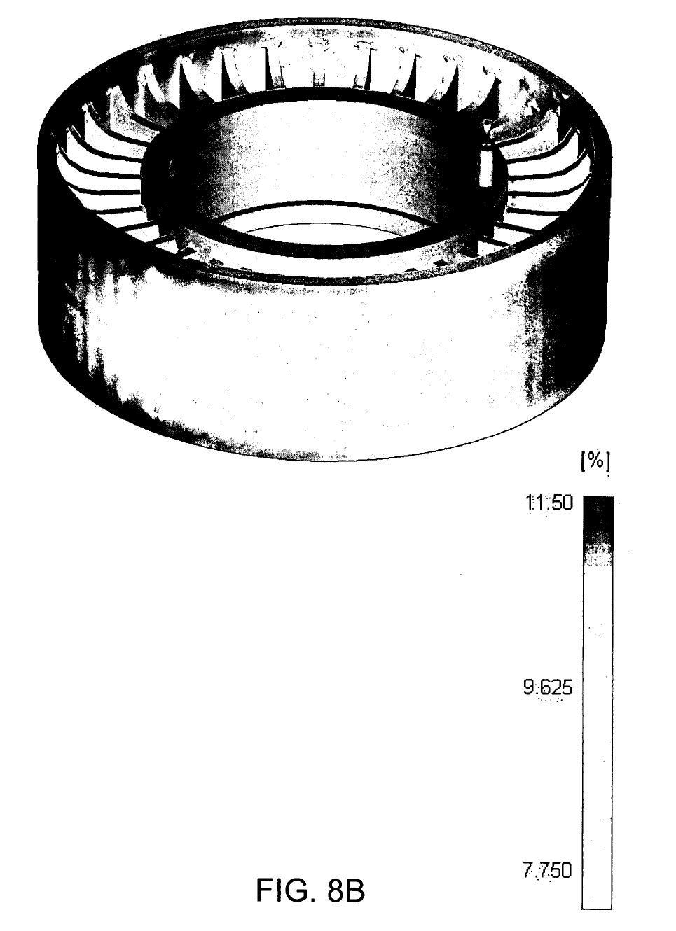

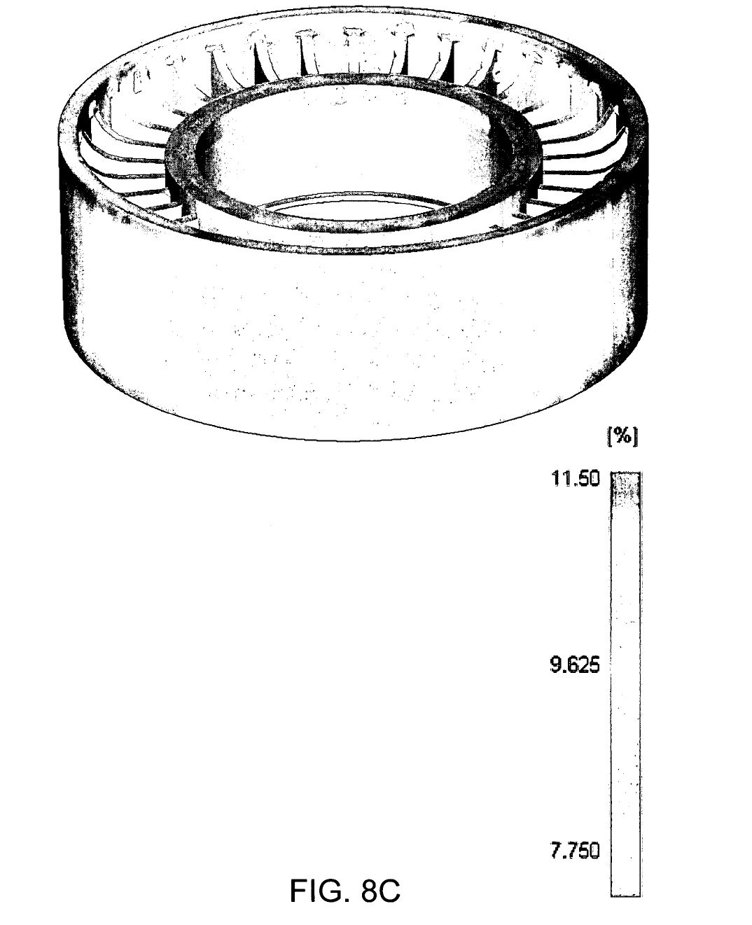

FIGS. 6, 7, and 8 show the results of computer simulations of flow patterns of the fiber-filled plastic material during injection molding for multiple gating, single gating, and disc gating (i.e., the gating used in accordance with the preferred embodiments of the invention). In particular, FIG. 6 shows fiber orientation for these three types of gating, FIG. 7 shows the material pressure profile, and FIG. 8 shows the volumetric shrinkage.

As can be seen in FIGS. 6A and 6B, the multiple and single gating methods produce knitlines 56 on the bearing engaging surface 54 of the plastic body. These knitlines cause non-uniform shrinkage of the plastic against the outer race of the bearing thus applying forces to the bearing which can shorten its useful life. These knitlines can also reduce bearing retention strength and the durability of the plastic body. In comparison, as shown in FIG. 6C, disc gating is free of such knitlines on the bearing engaging surface. FIG. 6A also shows knitlines 58 on the belt-engaging surface of the pulley. The non-uniform shrinkage from these knitlines leads to out-of-roundness of the belt-engaging surface as well as durability and low strength problems for the pulley as a whole.

FIG. 7 and, in particular, FIG. 7B shows that single gating produces a non-uniform pressure profile on the belt-engaging surface. This non-uniform pressure profile results in non-uniform shrinkage of the belt-engaging surface, which in turn leads to out-of-roundness.

FIG. 8 shows the overall volumetric shrinkage for the three cases. As can be seen in this figure, the disc gating (FIG. 8C) has substantially more uniform volumetric shrinkage, resulting in significantly lower levels of out-of-roundness.

By using the preferred disc gating system in combination with perimeter venting, pulleys having out-of-roundness levels of less than 35 microns over their entire operative belt-engaging surface are achieved. The following example illustrates the role of perimeter venting in producing this result.

### Comparative Example

This example illustrates the importance of the use of perimeter vent 52 at the junction between the cavity sub-insert (see 40 in FIGS. 4 and 5) and the main cavity insert (see 38 in FIGS. 4 and 5).

Two series of pulleys were manufactured using the mold of FIGS. 4 and 5, with and without perimeter vent 52. In both cases, the surface of the main cavity which defined the belt-engaging surface was jig ground. The pulleys were made of nylon 6 and were filled with glass fibers. The glass fibers had an aspect ratio of greater than 100:1, an average diameter of approximately 12 microns, and comprised 50% by weight of the body of the pulley.

Out-of-roundness was measured for representative samples from the two sets of pulleys. The mold system without perimeter vent 52 achieved an average out-of-roundness of 42 microns (n=3), while the mold system with perimeter vent 52 achieved an average out-of-roundness of 23 microns (n=3). Further studies using the mold with perimeter vent 52 gave an average out-of-roundness of 25 microns with a standard deviation of 3.8 microns (n=30).

These out-of-roundness values represent the maximum out-of-roundness found at any location on the belt-engaging surface up to 1 millimeter from the outside edges of the belt-engaging surface, i.e., they were not limited to the ±6 mm band around the centerline. They thus represent a more severe test for out-of-roundness in that the out-of-roundness at the center region of the pulley's belt-engaging surface is generally smaller than that near its edges.

This comparative data demonstrates that the use of perimeter vent 52 achieved a significant reduction in out-of-roundness, specifically, a reduction of 45%.

Although preferred and other embodiments of the invention have been described herein, further embodiments and a variety of modifications will be evident to persons of ordinary skill in the art from the present disclosure. The following claims are intended to cover the specific embodiments set forth herein as well as such modifications, variations, and equivalents.

What is claimed is:

1. A pulley for engagement with a belt comprising:
(A) an injection-molded body composed of a plastic material filled with a glass fiber reinforcing material; and
(B) a bearing which is partially encapsulated in the body; wherein:
(i) the body has a non-machined, belt-engaging surface which has a diameter D and a circumferential centerline;
(ii) the belt-engaging surface has an outside-edge-to-outside-edge width of at least 20 millimeters;
(iii) the belt-engaging surface has an out-of-roundness which is:
(a) less than or equal to 30 microns when measured at the circumferential centerline of the belt-engaging surface;
(b) less than or equal to 30 microns when measured at ±6 millimeters of the circumferential centerline of the belt-engaging surface; and
(c) less than or equal to 35 microns when measured at any location up to 1 millimeter from the outside edges of the belt-engaging surface;
(iv) the glass fiber reinforcing material comprises at least 15% by weight of the body; and
(v) the aspect ratio of at least 50% of the glass fibers of the glass fiber reinforcing material is at least 50:1.

2. The pulley of claim 1 wherein the belt-engaging surface has an out-of-roundness of approximately 25 microns when measured at the circumferential centerline of the belt-engaging surface.

3. The pulley of claim 2 wherein the belt-engaging surface has an out-of-roundness of approximately 25 microns when measured at ±6 millimeters of the circumferential centerline of the belt-engaging surface.

4. The pulley of claim 1 wherein D≦100 millimeters.

5. The pulley of claim 1 wherein the plastic material is thermoplastic.

6. The pulley of claim 1 wherein the glass fiber reinforcing material comprises approximately 50% by weight of the body.

7. The pulley of claim 1 wherein the belt-engaging surface does not include knit lines originating from gating of the plastic material forming the body.

8. The pulley of claim 1 wherein the belt-engaging surface is a flat cylindrical surface.

9. The pulley of claim 1 wherein the belt-engaging surface is a grooved cylindrical surface.

10. The pulley of claim 1 wherein the belt-engaging surface has a first edge and a second edge and the pulley is produced by injection molding using a mold having perimeter vents at both the first and second edges.

11. A method of producing a plastic pulley, said pulley having a belt-engaging surface which has a first edge and a second edge, said method comprising injection molding a plastic material containing glass fibers around a bearing using a disc gating process wherein the mold used in the injection molding process has perimeter vents at both the first and second edges and the belt-engaging surface of the molded pulley without any machining has an out-of-roundness which is less than or equal to 35 microns when measured at any location up to 1 millimeter from the first and second edges of the belt-engaging surface.

12. The method of claim 11 wherein the glass fibers comprise at least 15% by weight of the material which is injection molded around the bearing.

13. The method of claim 12 wherein the glass fibers comprise approximately 50% by weight of the material which is injection molded around the bearing.

14. The method of claim 11 wherein the aspect ratio of at least 50% of the glass fibers is at least 50:1.

15. The method of claim 11 wherein the plastic material is thermoplastic.
